(19) United States
(12) Patent Application Publication
(10) Pub. No.: US 2009/0199836 A1
(43) Pub. Date: Aug. 13, 2009

(54) CARBON NANOTUBE REINFORCED WIRESAW BEAM USED IN WIRESAW SLICING OF INGOTS INTO WAFERS

(75) Inventor: Puneet Gupta, Pasadena, TX (US)

Correspondence Address: Richard A. Schuth (MEMC);Armstrong Teasdale LLP, One Metropolitan Square, Suite 2600, St. Louis, MO, 63102-2740, US

(73) Assignee: MEMC ELECTRONIC MATERIALS, INC., St. Peters, MO (US)

(21) Appl. No.: 12/367,058

(22) Filed: Feb. 6, 2009

Related U.S. Application Data
(60) Provisional application No. 61/027,512, filed on Feb. 11, 2008.

(51) Int. Cl. B28D 1/08; B28D 5/04

(52) U.S. Cl. 125/20; 125/21; 125/36; 451/299

(57) ABSTRACT

A wiresaw beam for use in an apparatus for slicing wafers from an ingot, such as semiconductor wafers from a single crystal ingot or a polycrystalline silicon ingot. The wiresaw beam may be made from a polymer composite material comprising a thermoset polymer resin and carbon nanotubes.

### CROSS-REFERENCE TO RELATED APPLICATIONS

This application claims the benefit of U.S. Provisional Application No. 61/027,512, filed Feb. 11, 2008.

### BACKGROUND

The field of the disclosure relates to enhancing the thermal and structural properties of a wiresaw beam that is an intermediate bonding material between a single crystal or polycrystalline ingot and an ingot holder that is used in the wiresaw cutting of ingots and other materials that may be sliced into wafers.

Semiconductor-grade wafers are generally prepared from a single crystal ingot, such as a single crystal silicon ingot. The ingot is sliced into individual wafers which are subsequently subjected to a number of processing operations (e.g., lapping, etching, and polishing) to remove damage caused by the slicing operation and to create a relatively smooth finished wafer having uniform thickness and a finished front surface.

Silicon wafers may be sliced from an ingot using an inner diameter (“ID”) saw or a wire-type saw (“wiresaw”). Wiresaws are generally more efficient since wiresaws can slice the entire ingot at once as compared to an ID saw which can only produce a single wafer at a time.

An exemplary wiresaw slicing apparatus for slicing a single crystal silicon ingot into individual wafers is illustrated in FIG. 1, designated in its entirety by the reference numeral 21. Another exemplary wiresaw slicing apparatus is illustrated and described in U.S. Publication No. 2003/0170948, the disclosure of which is incorporated herein by reference. Commercially available wiresaw slicing apparatus include for example, Model 300E12-H made by HCT Shaping Systems of Cheseaux, Switzerland. Other models and types of wiresaw slicing apparatus may be utilized without departing from the scope of the present disclosure.

The apparatus generally comprises a frame 23 which mounts four wire guides 25 (two are partially shown) for supporting a wire web 27. The frame also mounts a movable slide or head 29 which mounts an ingot 30 for movement relative to the frame for forcing an ingot 30 into the web.

The wire guides 25 are generally cylindrical and have a number of peripheral grooves (not shown) that receive respective wire segments making up the wire web 27 and are spaced at precise intervals. The spacing between the grooves determines the spacing between wire segments and thereby determines the thickness of the sliced wafers. The wire guides 25 rotate on bearings for moving the wire segments lengthwise or axially. A cutting-slurry is directed onto the wire web 27 by conduits 32.

In the wafer slicing operation for producing silicon wafers, the single crystal silicon ingot is mounted on an ingot holder 53, which is held in the wiresaw apparatus by a table 51. The ingot 30 is adhered to a wiresaw beam. The surfaces of the ingot holder 53 and the ingot 30 are adhered to the wiresaw beam using a suitable adhesive.

After the adhesives that hold the ingot and the ingot holder to the wiresaw beam have cured, the assembly is inverted and mounted onto the wiresaw. The ingot is gradually lowered into a “web” of fast moving, ultrathin wire. The cutting action is created by pouring abrasive slurry on the wire web, which is actually a single wire being fed from one spool to another. Immediately after slicing, the “as cut” wafers are cleaned in a series of chemical baths to remove any residual slurry. From here, the wafers are polished and cleaned.

Wiresaw slicing generates frictional heat at the moving front representing the location of the cut. Though heat is partially convected away by the slurry, the remaining heat conducts through the ingot, wiresaw beam, and ingot holder assembly. Among the three, epoxy resin conventionally used to make the wiresaw beam has material properties characterized by relatively ineffective vibration dampening, large coefficient of thermal expansion (CTE) and lowest thermal conductivity. These characteristics of the epoxy resin of the wiresaw beam are thought to play a significant role in affecting the surface quality of the sliced wafer, particularly towards the end of the slicing operation when the stiffness of the ingot has been substantially reduced as a result of slicing.

### SUMMARY

Briefly, therefore, the disclosure is directed to a wiresaw beam for use in wiresaw slicing, in particular, a wiresaw beam constructed from a polymeric composite material comprising a polymeric resin and carbon nanotubes.

One aspect of the disclosure is directed to an apparatus for slicing semiconductor wafers from a single crystal ingot or a polycrystalline ingot. The apparatus includes a wire web for slicing the ingot into wafers. The apparatus also includes a frame. The frame includes a head for supporting the ingot during slicing. The head includes an ingot holder and a wiresaw beam. The wiresaw beam is constructed from a polymer composite material comprising a thermoset polymer resin and carbon nanotubes.

Another aspect of the disclosure is directed to an assembly for use in an apparatus for slicing semiconductor wafers from a single crystal ingot or a polycrystalline ingot. The assembly includes an ingot holder and a wiresaw beam. The wiresaw beam is constructed from a polymer composite material comprising a thermoset polymer resin and carbon nanotubes.

Yet another aspect of the disclosure is directed to a wiresaw beam for use with a wiresaw for slicing semiconductor wafers from a single crystal ingot or a polycrystalline ingot. The wiresaw beam is constructed from a polymer composite material comprising a thermoset polymer resin and carbon nanotubes.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 illustrates a wiresaw slicing apparatus; and

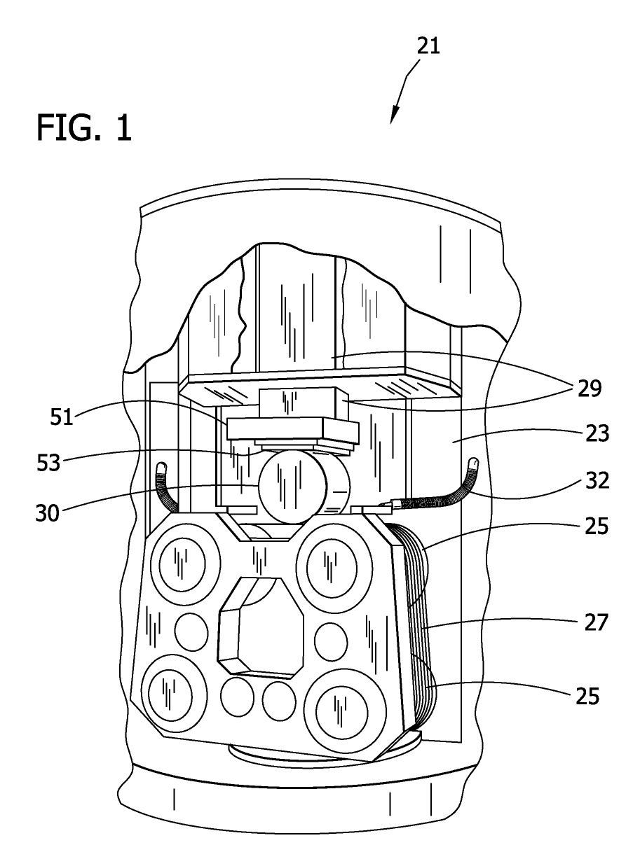

FIG. 2 illustrates an ingot affixed to an ingot holder through a wiresaw beam.

Corresponding reference characters indicate corresponding parts throughout the drawings.

### DETAILED DESCRIPTION

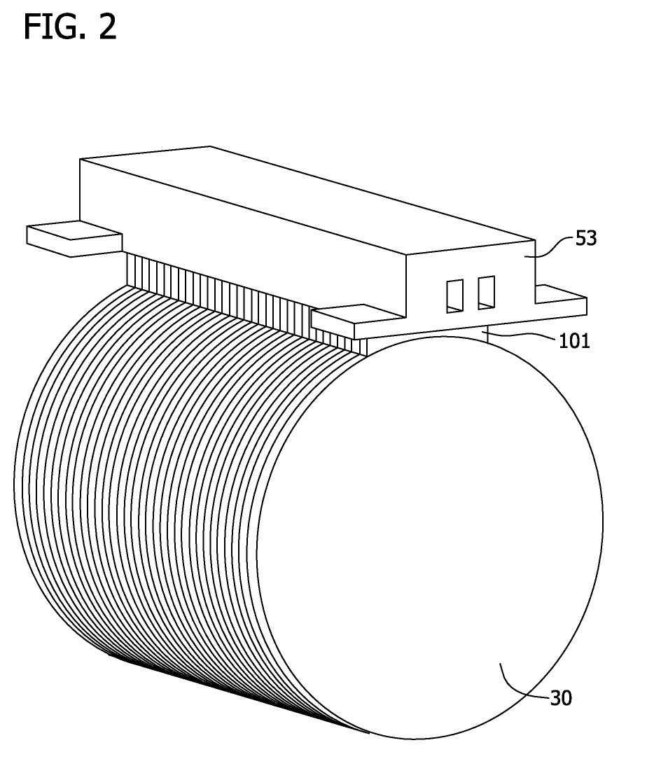

The present disclosure is directed to a polymer composite material useful in the construction of a wiresaw beam. The wiresaw beam is used in conjunction with an ingot holder in the wiresaw cutting of single crystal silicon ingots and ingots prepared from other materials. With reference now to FIG. 2, the wiresaw beam 101 serves as an interface between the ingot holder 53 and the single crystal ingot 30. The wiresaw beam 101 is held in place between the ingot holder 53 and the ingot 30 using a suitable adhesive. In FIG. 2, the ingot 30 is illustrated after a wiresaw slicing operation has taken place.

The crystal ingot is typically a single crystal silicon ingot or polycrystalline silicon ingot, more typically a single crystal silicon ingot. Although single crystal silicon is a preferred material for semiconductor-grade wafers, other semiconductor materials may be used.

The ingot holder illustrated in FIG. 2 may be constructed from steel or other materials, such as, for example, INVAR (an alloy of iron (64%) and nickel (36%) with some carbon and chromium).

According to one embodiment, the polymer composite material used to construct the wiresaw beam 101 is characterized by increased vibration damping (energy dissipation) capability, increased stiffness, enhanced thermal conductivity, and reduced coefficient of thermal expansion compared to conventional wiresaw beam materials. The polymer composite material may be prepared by incorporating carbon nanotubes (CNTs) during manufacture of the wiresaw beam. In one embodiment, the polymer composite material comprising carbon nanotubes is useful as an interface material between an ingot holder and a silicon ingot, wherein the ingot holder is used in wiresaw cutting of the silicon ingot. The polymer composite material possessing the superior physical properties herein described leads to sliced wafers with better surface quality.

According to one embodiment, the wiresaw beam 101 is constructed from polymer composite material comprising a polymer resin and carbon nanotubes. Suitable polymer resins for use in constructing the polymer composite material include thermoset polymer resins. Particularly suitable thermoset polymer resins are epoxy resins. In one embodiment, the epoxy resin is selected from the group consisting of a diglycidyl ether of bisphenol A, a diglycidyl ether of bisphenol F, a triglycidyl ether of triphenomethane, a polyglycidyl ether of novolac, a polyglycidyl ether cresol novolac, a polyglycidyl ether of napthalenic phenol, and methyl, ethyl, propyl, butyl substituted versions thereof and mixtures thereof. Exemplary epoxy resins include difunctional bisphenol-A/epichlorohydrin derived liquid epoxy resin (for example, EPON Resin 828 available from Hexion Specialty Chemicals, Houston, Tex.); low viscosity, liquid diglycidyl ether of Bisphenol-F epoxy resin derived from epichlorohydrin and Bisphenol-F (for example, EPON Resin 862 available from Resolution Performance Products, Houston, Tex.); and System 2000 Epoxy Laminating System (available from Fibre Glast Development Corporation, Brookville, Ohio).

Typically, the ingot holder and crystal ingot are comparable in terms of stiffness and strength. Conventional epoxy resins for use in the wiresaw beam are typically characterized by less stiffness and strength compared to the ingot holder and crystal ingot. Certain properties of the silicon ingot, steel ingot holder, and conventional epoxy resin beam are shown in Table 1 below.

TABLE 1
Material properties of the silicon ingot, ingot holder and expoxy
resin beam

| | | Steel | Epoxy |
|---|---|---|---|
| | Silicon | Ingot | Resin |
| Properties at 300 K | Ingot | Holder | Beam |
| Density (kg/mm³) | 2.30E−06 | 7.900E−06 | 1.587E−06 |
| Specific Heat (J/kg-K) | 7.30E+02 | 5.000E+02 | 1.010E+03 |
| Thermal Conductivity | 1.439E−01 | 1.500E−02 | 6.200E−04 |
| (W/mm · K) | | | |
| CTE (/K) | 2.568E−06 | 1.750E−05 | 6.600E−05 |
| Young's Modulus | 1.300E+08 | 2.000E+08 | 7.068E+06 |
| (kg/m · s²) | | | |
| Poisson-Ratio | 2.785E−01 | 3.000E−01 | 3.243E−01 |

It is apparent from Table 1 that the conventional epoxy resin has the lowest thermal conductivity, the highest coefficient of thermal expansion, and the lowest Young's Modulus (an indicator of stiffness). These characteristics of conventional epoxy resin beams negatively influence the surface quality of the sliced wafer, particularly towards the end of the slicing operation when the stiffness of the ingot has been substantially reduced as a result of slicing.

The enhancement of these and other physical properties of the wiresaw beam may be accomplished by reinforcing conventional epoxy resins with carbon nanotubes (CNTs). The added carbon nanotubes may be any of the several kinds of CNTs, including Single-Walled Nanotubes (SWNTs), Double-Walled Nanotubes (DWNTs) or Multi-Walled Nanotubes (MWNTs). Carbon nanotubes of the above-described types are commercially available from a variety of sources. One such vendor is Helix Material Solutions (Richardson, Tex.).

The types of carbon nanotubes may vary with regard to their diameters and specific surface areas. For example, SWNTs may have a diameter between about 1 nm to about 2 nm, typically between about 1.2 nm and about 1.4 nm, such as about 1.3 nm. DWNTs typically have a diameter on the order of about 4 nm. MWNTs are available in diameters of less than about 10 nm, between about 10 nm and about 20 nm, between about 10 nm and about 30 nm, between about 20 nm and about 40 nm, between about 40 nm and about 60 nm, and between about 60 nm and about 100 nm. With regard to specific surface area, SWNTs and DWNTs typically have a surface area between 300 m2/g and about 600 m2/g. MWNTs typically have a surface area between 40 m2/g and about 300 m2/g. Carbon nanotubes of all types may have a length typically between about 0.5 μm and about 40 μm. Nanotubes may be prepared to have shorter lengths, such as between about 0.5 μm and about 3 μm or between about 1 μm and about 2 μm.

Carbon nanotubes are particularly applicable for adding to the polymer composite material used as a wiresaw beam because of their stiffness, tensile strength, and low density. For example, carbon nanotubes have a theoretical Young's Modulus as high as about 1 TPa (SWNTs) or even as high as about 1.25 TPa (MWNTs). This is approximately 2 orders of magnitude higher than the Young's modulus of conventional epoxy resin materials. Moreover, carbon nanotubes have been produced having a maximum tensile strength as high as about 60 GPa. The density of carbon nanotubes is typically between about 1.3×10-6 kg/mm3 to about 1.4×10-6 kg/mm3, which is less than the density of the epoxy resin materials. Therefore, the carbon nanotubes do not significantly add to the weight of the wiresaw beam.

To achieve the advantageous properties of enhanced stiffness, strength, and vibration damping, the carbon nanotubes may be added to the polymer composite material in an amount as high as about 50% by weight. Preferably, the amount of carbon nanotubes is lower due to cost considerations and diminishing returns as the carbon nanotube concentration is increased. Accordingly, the carbon nanotubes may be added to the polymer composite material in an amount less than about 20% by weight, typically less than about 10% by weight, more typically less than about 5% by weight, such as less than about 3% by weight. The carbon nanotubes are added in an amount of at least about 0.01% by weight to achieve the desired effects of increased vibration damping capability, increased composite stiffness, increase composite thermal conductivity, and reduced coefficient of thermal expansion. Accordingly, the carbon nanotube concentration is preferably between about 0.01% by weight to about 3% by weight, such as between about 1% by weight and about 2% by weight.

In one embodiment, the amount of carbon nanotubes in the wiresaw beam is from about 0.01% to about 50% by weight. In other embodiments, the amount of carbon nanotubes in the wiresaw beam is from about 0.01% to about 25% by weight, from about 0.01% to about 10% by weight, from about 0.01% to about 5% by weight, from about 0.01% to about 3% by weight, from about 0.01% to about 1% by weight or even from about 0.01% to about 0.1% by weight. In yet other embodiments, the amount of carbon nanotubes in the wiresaw beam is from about 0.1% to about 50% by weight, from about 1% to about 50% by weight, from about 3% to about 50% by weight, from about 5% to about 50% by weight, from about 10% to about 50% by weight or even from about 25% to about 50% by weight.

Since the CNTs are characterized by extremely small dimensions, special care must be taken to ensure their uniform distribution in the epoxy resin. In one embodiment, a high-shear mixer is used to disperse the CNTs in the epoxy resin matrix prior to and/or during the polymerization reaction. The epoxy resin may be prepared substantially according to the instructions provided by the manufacturers, except for the addition of the carbon nanotubes. Sonication may be used to assist in dispersion of CNTs in the resin. Further, organic solvents, such as acetone, that are compatible with the resin may be added to enhance uniform dispersion in the resin matrix. Moreover, dispersing agents, such as surfactants, may also be added during the polymerization reaction. The solvents and dispersing agents may be removed by methods known in the art.

After polymerization, the soft, liquid epoxy resin material comprising carbon nanotubes and optionally solvent is poured into a mold. The epoxy resin is cured in the mold by baking in an oven set to a temperature suggested by the epoxy manufacturer's instructions. After curing, the wiresaw beam comprising the cured epoxy resin is removed from the mold and adhered to the ingot holder along the beam's major, lengthwise surface using a suitable adhesive.

Property characterization of the CNT reinforced matrix is achieved through testing using standardized test methods like the ASTM.

Having described the invention in detail, it will be apparent that modifications and variations are possible without departing from the scope of the invention defined in the appended claims.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description and shown in the accompanying drawing[s] shall be interpreted as illustrative and not in a limiting sense.

What is claimed is:

1. An apparatus for slicing semiconductor wafers from a single crystal ingot or a polycrystalline ingot comprising:
a wire web for slicing the ingot into wafers; and
a frame including a head for supporting the ingot during slicing, the head comprising an ingot holder and a wiresaw beam constructed from a polymer composite material comprising a thermoset polymer resin and carbon nanotubes.

2. An apparatus as set forth in claim 1 wherein the thermoset polymer resin is an epoxy resin.

3. An apparatus as set forth in claim 2 wherein the expoxy resin is selected from the group consisting of a diglycidyl ether of bisphenol A, a diglycidyl ether of bisphenol F, a triglycidyl ether of triphenomethane, a polyglycidyl ether of novolac, a polyglycidyl ether cresol novolac, a polyglycidyl ether of napthalenic phenol, and methyl, ethyl, propyl, butyl substituted versions thereof and mixtures thereof.

4. An apparatus as set forth in claim 1 wherein the amount of carbon nanotubes in the wiresaw beam is from about 0.01% to about 50% by weight.

5. An apparatus as set forth in claim 1 wherein the amount of carbon nanotubes in the wiresaw beam is from about 0.01% to about 3% by weight.

6. An apparatus as set forth in claim 1 wherein the amount of carbon nanotubes in the wiresaw beam is from about 0.1% to about 50% by weight.

7. An apparatus as set forth in claim 1 wherein the amount of carbon nanotubes in the wiresaw beam is from about 1% to about 50% by weight.

8. An assembly for use in an apparatus for slicing semiconductor wafers from a single crystal ingot or a polycrystalline ingot, the assembly comprising:
an ingot holder; and
a wiresaw beam constructed from a polymer composite material comprising a thermoset polymer resin and carbon nanotubes.

9. An assembly as set forth in claim 8 wherein the thermoset polymer resin is an epoxy resin.

10. An assembly as set forth in claim 9 wherein the expoxy resin is selected from the group consisting of a diglycidyl ether of bisphenol A, a diglycidyl ether of bisphenol F, a triglycidyl ether of triphenomethane, a polyglycidyl ether of novolac, a polyglycidyl ether cresol novolac, a polyglycidyl ether of napthalenic phenol, and methyl, ethyl, propyl, butyl substituted versions thereof and mixtures thereof.

11. An assembly as set forth in claim 8 wherein the amount of carbon nanotubes in the wiresaw beam is from about 0.01% to about 50% by weight.

12. An assembly as set forth in claim 8 wherein the amount of carbon nanotubes in the wiresaw beam is from about 0.01% to about 3% by weight.

13. An assembly as set forth in claim 8 wherein the amount of carbon nanotubes in the wiresaw beam is from about 0.1% to about 50% by weight.

14. An assembly as set forth in claim 8 wherein the amount of carbon nanotubes in the wiresaw beam is from about 1% to about 50% by weight.

15. A wiresaw beam for use with a wiresaw for slicing semiconductor wafers from a single crystal ingot or a polycrystalline ingot, wherein the wiresaw beam is constructed from a polymer composite material comprising a thermoset polymer resin and carbon nanotubes.

16. A wiresaw beam as set forth in claim 15 wherein the thermoset polymer resin is an epoxy resin.

17. A wiresaw beam as set forth in claim 16 wherein the expoxy resin is selected from the group consisting of a diglycidyl ether of bisphenol A, a diglycidyl ether of bisphenol F, a triglycidyl ether of triphenomethane, a polyglycidyl ether of novolac, a polyglycidyl ether cresol novolac, a polyglycidyl ether of napthalenic phenol, and methyl, ethyl, propyl, butyl substituted versions thereof and mixtures thereof.

18. A wiresaw beam as set forth in claim 15 wherein the amount of carbon nanotubes in the wiresaw beam is from about 0.01% to about 50% by weight.

19. A wiresaw beam as set forth in claim 15 wherein the amount of carbon nanotubes in the wiresaw beam is from about 0.01% to about 3% by weight.

20. A wiresaw beam as set forth in claim 15 wherein the amount of carbon nanotubes in the wiresaw beam is from about 0.1% to about 50% by weight.

21. A wiresaw beam as set forth in claim 15 wherein the amount of carbon nanotubes in the wiresaw beam is from about 1% to about 50% by weight.
